(19) United States
(12) Patent Application Publication
(10) Pub. No.: US 2010/0109831 A1
(43) Pub. Date: May 6, 2010

(54) INDUCTION COIL WITHOUT A WELD

(75) Inventors: Andrew Lawrence Podevels, University Heights, OH (US); Gary Robert Allen, Chesterland, OH (US); Aaron Edward Franczyk, Mayfield Heights, OH (US); Glenn Howard Kuenzler, Beachwood, OH (US); Derek Lee Watkins, Elizabethtown, KY (US); Joshua Ian Rintamaki, Westlake, OH (US); Jianwu Li, Solon, OH (US)

Correspondence Address: FAY SHARPE LLP, 1228 Euclid Avenue, 5th Floor, The Halle Building, Cleveland, OH, 44115, US

(73) Assignee: General Electric Company

(21) Appl. No.: 12/263,222

(22) Filed: Oct. 31, 2008

(51) Int. Cl. H01F 7/06; H01F 27/28

(52) U.S. Cl. 336/232; 29/605

(57) ABSTRACT

A multi-turn coil formed from a single sheet of conductive material and the method of forming same eliminates the use of a weld. The multi-turn coil includes a single sheet of conductive material having at least a first turn in a first plane, and at least a second turn in a second plane, where the first plane is parallel to the second plane. An interconnecting fold interconnects the first and second turns, and any additional turns. The method of forming a multiple turn coil includes providing a continuous strip of conductive material having at least first and second turns extending through substantially 360° and formed in a first plane. The method further includes displacing at least the first turn from the first plane into generally overlapping, parallel relation with the second turn.

### BACKGROUND OF THE DISCLOSURE

The present disclosure relates generally to electrodeless high intensity discharge (HID) lamps. More particularly, the present disclosure is directed to a multi-turn coil formed from a single sheet of metal for an HID lamp which eliminates any welds and improves the manufacturing process thereof.

A related disclosure, namely Attorney Docket Number 232385 (GECZ 2 00920) that is co-pending and filed simultaneously herewith, is directed to an electrodeless induction high intensity discharge lamp, and particularly a CMH lamp, that can enable lamp life on the order of approximately fifty thousand (50,000) hours. HID lighting was first developed in the 1960s and such lighting now provides approximately twenty percent (20%) of all artificial light globally. Metal halide HID lamps account for approximately one half (50%) of the HID total and are growing quickly. For example, metal halide HID lamps provide a unique combination of high efficacy, high brightness, high wattage, long life, and good color.

An induction CMH lamp is believed to potentially provide thirty to fifty percent (30%-50%) higher lumens per watt and luminance than a conventional electroded CMH lamp. Moreover, it is believed that such an induction CMH lamp will operate up to and beyond four hundred (400) watts, and have approximately two to three times longer lamp life along with acceptable color for many applications. Such a lamp is also advantageously mercury-free, whereas none of the emerging mercury-free lamp designs for electroded HID lamps offer efficacy levels competitive with an equivalent electroded mercury-dosed HID lamp. It is believed that eco-friendly lighting products, such as mercury-free and very high-efficacy induction CMH lamps, have the potential to serve a significant percentage of the present high-wattage HID market.

Commonly owned U.S. Pat. Nos. 5,039,903 and 5,214,357 are generally directed to an earlier generation of an electrodeless HID lamp upon which the present disclosure is a significant improvement. The disclosure of each of these patents is incorporated herein by reference. FIGS. 1 and 2 are representative of these patents and teach an electrodeless HID lamp that capacitively or inductively couples a high frequency RF current to a gas fill contained in an arc tube. An excitation coil is disposed in circumferentially surrounding relation to the arc tube so that inductively coupled high-frequency RF current flowing in the excitation coil provides a time-varying magnetic field which produces an electric field within the arc tube. As a result, a toroidally shaped arc discharge is produced in the fill. Consequently, it is important to locate the excitation coils adjacent the arc body and further to have a profile or reduced height so as not to adversely impact on the light output from the discharge.

It is also important, of course, to minimize energy losses in the lamp arrangement. Particularly, use of an excitation coil and a capacitor member constructed of a material that is a good electrical and thermal conductor, for example sheet stock of a metal having high thermal and electrical conductivity such as sheet stock of aluminum or copper has been used previously. Preferably, capacitor plate portions of the coil/capacitor member have a substantial cross-sectional area that maximizes heat transfer from the capacitor member to an adjoining heat sink. A preferred process of forming the capacitor and excitation coil uses a conventional punch press technique where the metal stock product is comprised of a single plate in which one portion is the capacitor portion, and the second portion is the excitation coil portion. The capacitor portion and the excitation coil portion are interconnected together. The connecting members that contiguously join the excitation coil with the capacitor portion are preferably shaped to minimize light blockage from the arc body. In the multi-turn coil arrangement, each coil turn is separately punched, finished, and bent to form a capacitive portion connected to the coil portion by an interconnecting member. A brazing or welding operation is then required to connect the two coil turns.

FIGS. 1 and 2 show a prior art arrangement of a circuit arrangement for an electrodeless HID light source or lamp assembly 100 that includes an inductive portion 104, shown here as first and second turns 104a, 104b (FIG. 2) of a conductive coil that receive power from a high frequency power source 106 surrounding a light source 108. The high frequency power source 106 (FIG. 1) provides a high frequency RF current which is inductively coupled to the electrodeless HID lamp and generates an arc within an arc body of the light source 108. The current generated by the circuit arrangement 106 results in a time-varying magnetic field which produces within the arc body, a solenoidal electric field that closes upon itself thereby causing a current flow within the arc body that results in a toroidal shaped arc discharge. The common frequency range of operation is between 0.1 and 300 megahertz (MHz) with an exemplary operating frequency being approximately 13.56 MHz, or a harmonic or sub-harmonic of 13.56 MHz.

A capacitive portion 114 includes first and second plate portions 114a, 114b, for example, that are preferably formed of sheet metal stock, such as aluminum, copper, or any other suitable metal. Preferably the metal has a high thermal and electrical conductivity. Moreover, the capacitor plate portions 114a, 114b have a substantial cross-sectional area that minimizes thermal impedance properties of the capacitor member. A dielectric material 120 is located or sandwiched between the capacitor plate portions 114a, 114b. Suitable dielectric materials include polytetrafluoroethylene (PTFE, or Teflon™), ceramic, mica, air, or other material having high temperature capability, high electrical resistivity, and preferably high dielectric constant.

Each of the capacitor plate portions connects to an interconnecting member 122a, 122b. The capacitor plate portions and/or the respective turns of the multi-turn coil 104a, 104b are brazed or welded to the interconnecting members in this prior art arrangement. The shape of each coil turn is limited so as to minimize the amount of light blockage from the arc body.

Although commercially viable, the brazing or welding operation adds time, cost, and significant quality challenges into the final assembly.

FIGS. 3-6 show another prior art arrangement, from Japanese patent application JP 10-162981A, of the inductive portion 1 of a conductive coil. In FIG. 3 shown here as first, second, and third sections 1a, 1b, 1c are the three sections required to form the two turns of a two-turn coil (FIG. 4) that receive power from a high frequency power source surrounding a light source. In FIG. 5 shown here as first, second, third, fourth, and fifth sections 1a, 1b, 1c, 1d, and 1e are the five sections required to form the three turns of a 3-turn coil (FIG. 6) that receive power from a high frequency power source surrounding a light source. Although this embodiment eliminates the undesirable weld or braze connecting the turns of a multi-turn coil, it requires more inductive sections and more interconnecting sections than the present disclosure. In general, this prior art requires 2n-1 round sections to provide a coil having n number of circular turns, for example three round sections for a 2-turn coil (n=2), four round sections for a 2.5-turn coil, five round sections for a 3-turn coil, and so on. Each pair of round sections is connected by a folded straight section that is folded by approximately 180 degrees to fabricate the multi-turn coil, so that there are 2n-2 interconnecting folds between the 2n-1 round sections of inductive turns, for example 2 folds for a 2-turn coil, 4 folds for a 3-turn coil, and so on.

Thus, a need exists for a multi-turn coil arrangement formed from a single sheet of metal that can be mechanically formed into the desired configuration and limits the number of inductive sections and likewise the number of interconnecting sections.

### SUMMARY OF THE DISCLOSURE

A multi-turn coil formed from a single sheet of conductive material and the method of forming same eliminates the use of a weld as in a current design.

The multi-turn coil includes a single sheet of conductive material having at least a first turn in a first plane, and at least a second turn in a second plane, where the first plane is parallel to the second plane. An interconnecting fold interconnects the first and second turns, and additional interconnecting folds interconnect any additional turns.

The first turn extends through substantially 360°, and likewise the second, and any additional, turn extends through substantially 360°.

The interconnecting fold is located along an outer perimeter portion of the first and second turns, and any additional turn. The required number of interconnecting folds is n-1 where n is the number of circular turns of the inductive coil. For example, one fold for a 2-turn coil, two folds for a 3-turn coil, and so on.

The first and second turns, and any additional turns, are preferably co-axial, and preferably have co-extensive inner and outer perimeters.

The first and second turns, and any additional turn, may be kept parallel in the plane of the stock material from which they were cut, or the turns may be further modified by stamping or bending into a conical or cupped configuration.

Lead portions extend in a preferred arrangement in generally tangential, parallel relation from the turns and interconnect with first and second plate portions.

The first and second plate portions are preferably disposed in parallel relation with one another and disposed generally perpendicular to the first and second planes.

A method of forming a multiple turn coil includes providing a continuous strip of conductive material having at least first and second turns that extend through substantially 360° and are formed in a first plane.

The method further includes displacing at least the first turn from the first plane into generally overlapping, parallel relation with the second turn.

The displacing step includes folding the strip of conductive material to align the first turn over the second turn.

The method includes orienting the first and second turns in the first plane, each of the turns proceeding from an interconnecting portion in opposite-hand directions from each other.

A primary benefit of the present disclosure is the ability to form a multi-turn coil from a single sheet of metal.

Another advantage provided by the present disclosure is the ability to eliminate a weld or brazed interconnection as used in conventional arrangements.

Another advantage provided by the present disclosure is the minimization of the number of interconnecting folds required to join the turns of a multi-turn coil. Each fold results in additional ohmic losses along the current-carrying path of the fold, without contributing to the inductive coupling of the coil, so the overall power efficiency of the of the multi-turn coil is maximized if the number of folds can be minimized.

The present disclosure offers the advantages of being easier to manufacture, less expensive to manufacture, and free of discontinuities in the coil that cause hot spots and risk of failure during operation associated with prior designs.

Still other benefits and advantages will become more apparent from reading and understanding the following detailed description.

### BRIEF DESCRIPTION OF THE DRAWINGS

FIG. 1 is an elevational view partially in section of a drive circuit arrangement for an electrodeless CMH lamp.

FIG. 2 is an elevational view taken along the lines 2-2 of FIG. 1.

FIG. 3 is a plan view of a stamped and cut conformation from a strip of sheet metal.

FIG. 4 is a cross-sectional view of the folded multi-turn coil formed from the strip shown in FIG. 3.

FIG. 5 is a plan view of a stamped and cut conformation from a strip of sheet metal.

FIG. 6 is a cross-sectional view of the folded multi-turn coil formed from the strip shown in FIG. 5.

FIG. 7 is a plan view of a stamped and cut conformation from a strip of sheet metal.

FIG. 8 is perspective view of the multi-turn coil formed from the cut and stamped component of FIG. 7.

FIG. 9 is a plan view of another configuration of a stamped and cut strip of sheet metal.

FIG. 10 is a perspective view of the multi-turn coil formed from the component of FIG. 9.

FIG. 11 is a plan view of another embodiment of a stamped and cut component from a sheet of metal.

FIG. 12 is a perspective view of a multi-turn coil formed from the cut component of FIG. 11.

FIG. 13 is a plan view of a stamped and cut configuration from a strip of metal sheet.

FIG. 14 is a perspective view of a multi-turn coil formed from the cut component of FIG. 13.

FIG. 15 is a view of an alternative embodiment showing an unfolded sheet of material cut to a desired shape.

FIG. 16 is a view of the embodiment of FIG. 15 illustrating a first folding step to form the coil.

FIG. 17 is a view similar to FIG. 16 and illustrating a slightly larger gap between adjacent turns of the coil.

FIG. 18 is a view of the embodiment of FIGS. 16 and 17 showing the coil after second and third folding steps.

FIG. 19 is a plan view of a stamped and cut conformation that is further stamped or bent to form conical or cupped turns from a strip of sheet metal.

FIG. 20 is a perspective view of the multi-turn coil formed from the cut and stamped component of FIG. 19.

FIG. 21 is a side view of the multi-turn coil of FIG. 19.

FIG. 22 is a typical L-shape matching network.

FIG. 23 is an electrical model of the coupling coil.

FIG. 24 is a schematic representation of matching the coupling coil to a design target.

FIG. 25 is another schematic representation of standard coil and matching.

FIG. 26 is a schematic illustration of increasing coil capacitance.

FIG. 27 is a schematic illustration of another circuit for increasing coil capacitance.

FIG. 28 is a plan view of a coupling with integrated capacitor.

FIG. 29 is a cross-sectional view of the multi-turn coil of FIG. 28 with an integrated dielectric material.

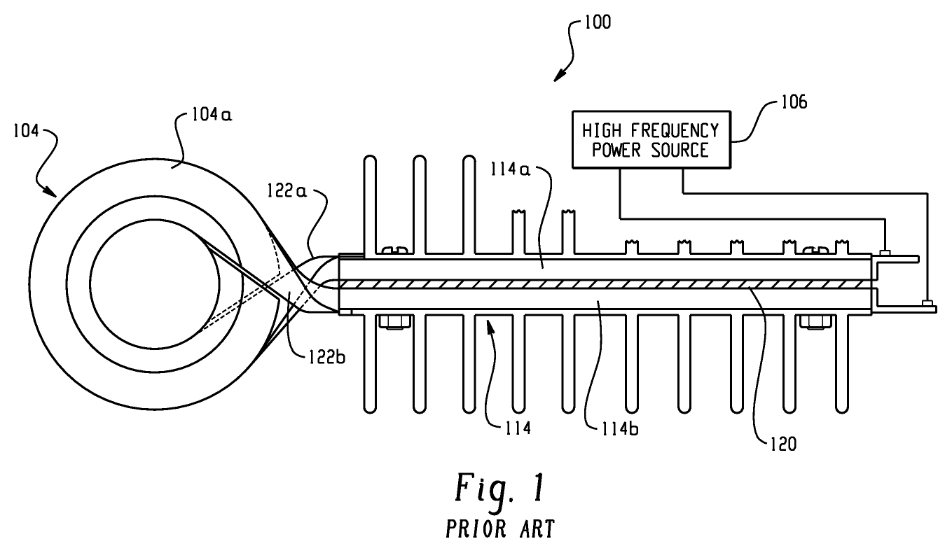

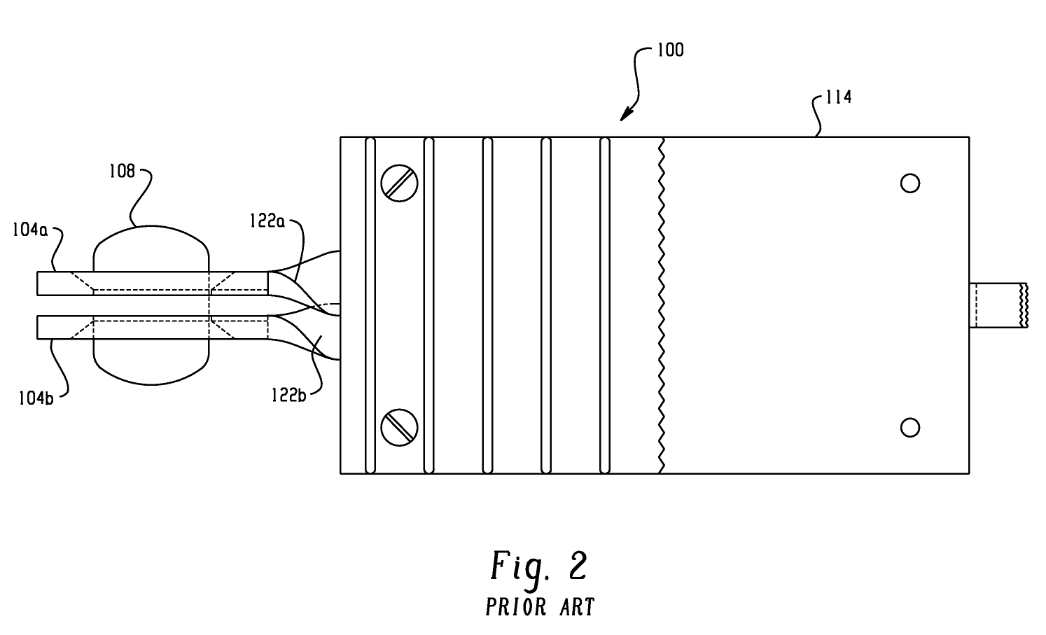

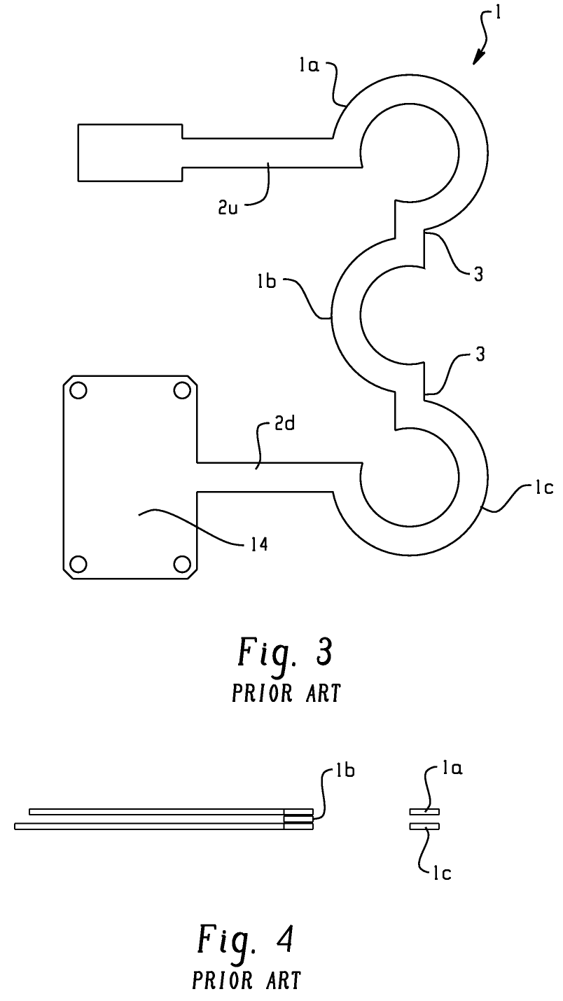

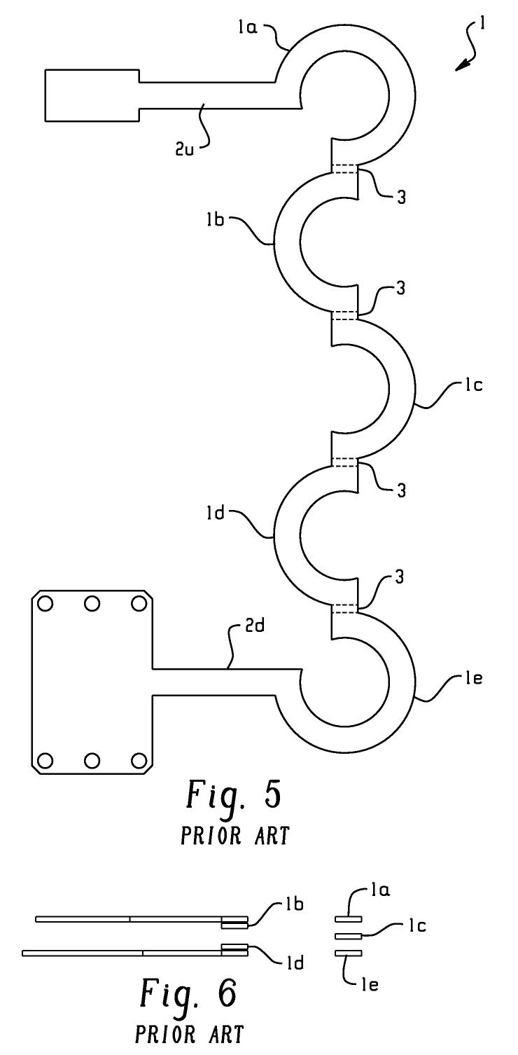

### DETAILED DESCRIPTION OF THE PREFERRED EMBODIMENTS

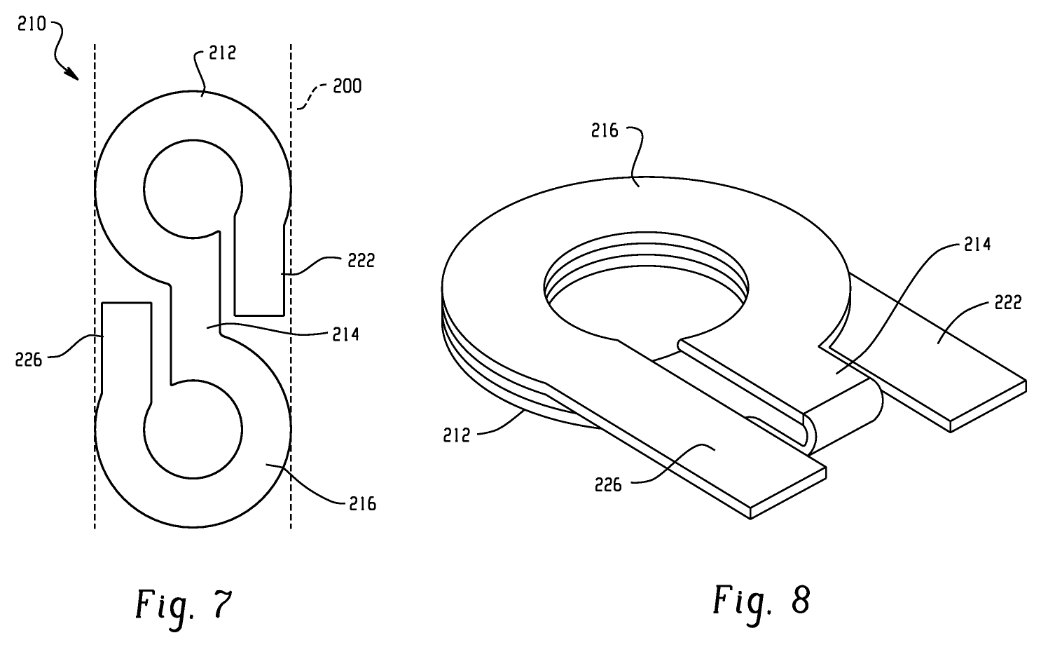

Turning to the present disclosure, FIG. 7 shows in phantom line or dotted line a strip of uncut stock metal sheet 200 that has a predetermined depth or thickness relative to the width. The optimal thickness of the sheet will coincide with minimizing light blockage from the light source, while maximizing thermal conductance and inductive coupling of current to the toroidal arc. A stamped and cutout component 210 is shown in solid line, so that in FIG. 7 the component has a substantially planar configuration as the component is stamped and separated from the remainder of the strip 200. The component 210 includes a first turn 212 that proceeds through substantially 360° from an interconnecting member 214 that connects with a second turn 216. The second turn extends in the opposite direction, or opposite-hand, from the first turn 212, and also proceeds through substantially 360°. Thus, each turn extends in opposite directions (opposite hand) from opposite ends of the interconnecting member 214. The single sheet 200 of conductive metal, aluminum for example, includes the first turn 212, interconnecting portion 214 and the second turn 212 in the same plane when stamped. The interconnecting portion 214 is subsequently folded along an intermediate region, preferably at approximately mid-length (see FIG. 8), so that the first and second turns are disposed in co-axial, substantially coextensive inner and outer perimeter alignment with one another, and the first and second turns are located in respective first and second parallel planes. The interconnecting fold is located along an outer perimeter portion of the first and second turns, and each turn extends through substantially 360° from the interconnecting fold.

Lead portions 222, 226 extend respectively from the first turn 212 and second turn 216 that are neither dominantly inductive nor capacitive but instead function to interconnect the capacitive plate portions with the inductive multi-turn coil. The lead portions are formed from the same sheet material 200 and are originally in plane with the first and second turns, and the interconnecting fold region 214 (FIG. 7). Thereafter, and as more particularly illustrated in FIG. 8, separate portions of the interconnecting fold are located in each of first and second planes that each respectively include a turn and lead portion. The first and second planes are disposed in parallel relation, and due to the minimal thickness of the turns of the coil, light output is not adversely impacted. Further, the openings through the turns are closely dimensioned to receive the outer perimeter of the arc body (not shown for ease of illustration, but as shown in FIG. 6) therein.

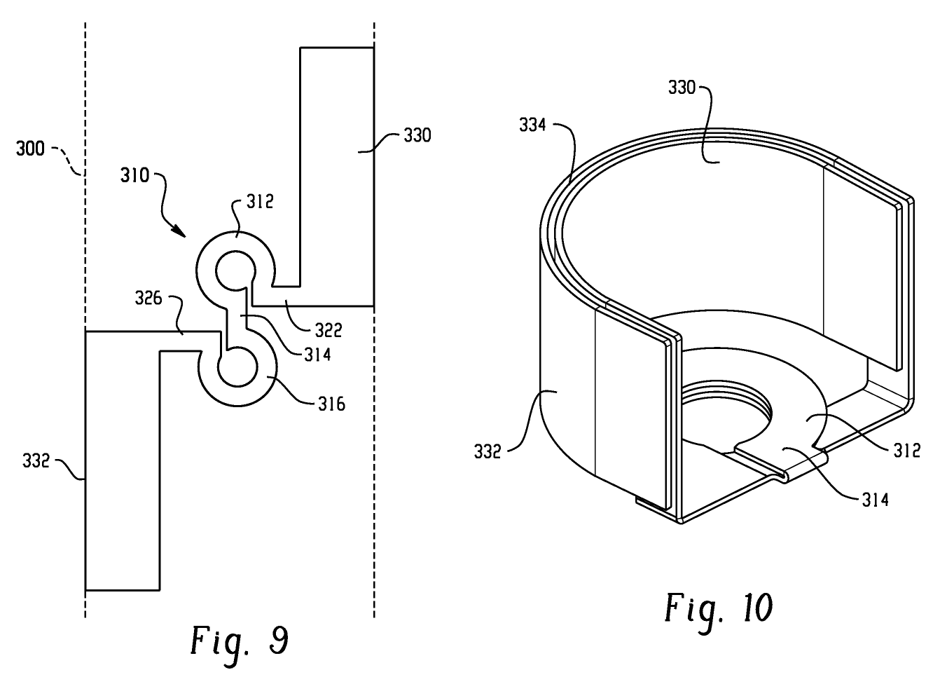

Another preferred embodiment is shown in FIGS. 9 and 10. Again, a single sheet of uncut stock sheet 300 of conductive metal material is provided. The configuration of a stamped and cut component 310 for forming a multi-turn coil includes a first turn 312 that extends from an interconnecting portion 314. The other end of the interconnecting portion is provided with a second turn 316. Again, each turn extends through substantially 360°. Moreover, and as evident in FIG. 9, the component 310 as stamped and separated from the sheet is disposed in a single plane, and then folded into the configuration shown in FIG. 10 where the interconnecting portion is folded along an intermediate region so that the first and second turns are disposed in first and second parallel, overlapping planes. The turns 312, 316 become co-axial in this arrangement and likewise the first and second turns have substantially co-extensive inner and outer perimeters, i.e., they are aligned relative to one another. Lead portions 322, 326 extend outwardly from a respective turn, and extend continuously into one end of capacitive plate portions 330, 332 that include a dielectric material 334 disposed between the plate portions. The primary function of the capacitive plate portions is to act as a capacitor; but the plate portions may also serve, in this embodiment, as a structural mount, or a light and heat shield, or a light reflector. In general, this embodiment shows that the capacitor plates may be arranged in a variety of configurations in proximity to, or removed from, the turns of the coil. In the folded configuration of FIG. 10, the plate portions form a generally U-shaped wall and may also include a reflective surface for directing light outward from the arc body received in the central, aligned openings of the first and second turns.

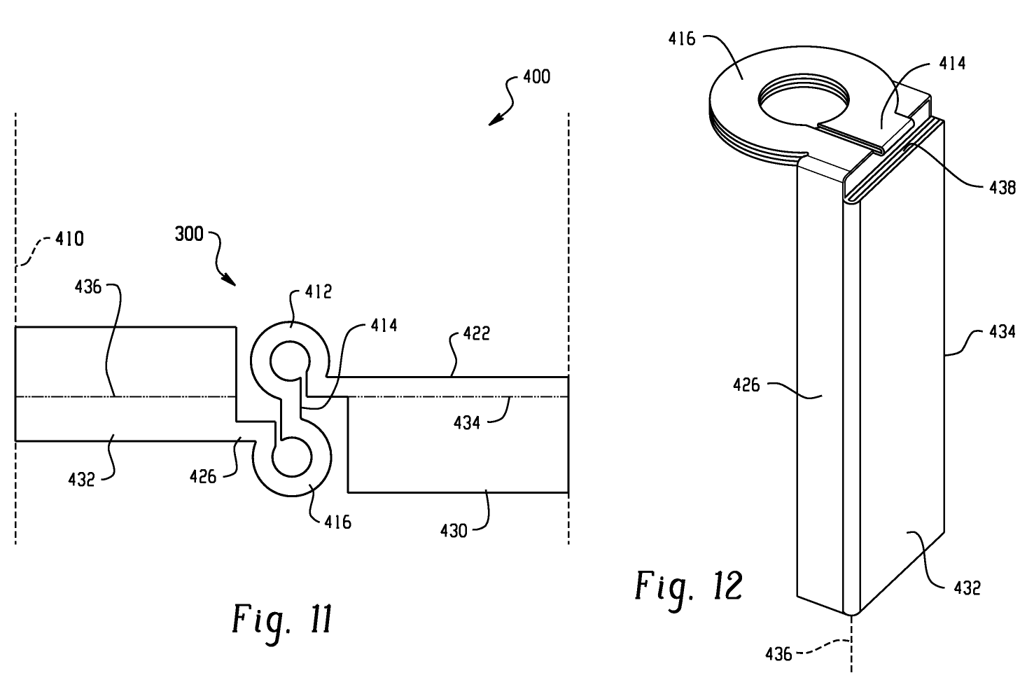

FIGS. 11 and 12 show another preferred embodiment in which a strip of uncut stock material 400 is stamped to form a planar component 410 separated from the remainder of the strip. In a manner similar to the prior embodiments, first and second turns 412, 416 extend through substantially 360°, and extend from opposite ends of an interconnecting portion 414. In addition, lead portions 422, 426 extend outwardly from a respective turn 412, 416. Enlarged, planar capacitive plate portions 430, 432 extend from a respective edge of lead portions 422, 426 along bend lines 434, 436, respectively. The folded configuration of the final coil about the interconnecting portion is shown in FIG. 12. The turns are disposed in overlapping parallel planes, and the turns are in coaxial relation for receiving the arc body in the central aligned openings of the turns. Further, the capacitive plate portions extend outwardly from the turns of the coil and bent in orthogonal relationship to one another along the bend lines 434, 436. The large, plate portions advantageously include a dielectric material 434 such as polytetrafluoroethylene (PTFE, or Teflon™), ceramic, mica, air, or other material having high temperature capability, high electrical resistivity, and preferably high dielectric constant therebetween.

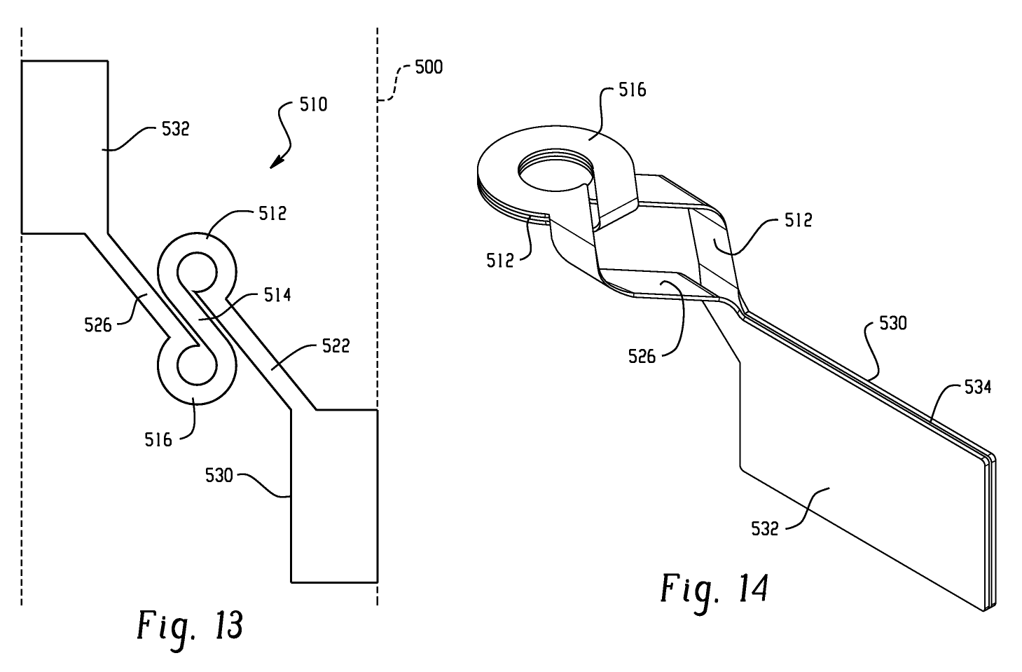

FIGS. 13 and 14 illustrate yet another embodiment of an uncut stock strip 500 of thermally and electrically conductive material from which is stamped or formed a substantially planar component 510 that is bent into integrated multi-turn coil portions and capacitive plate portions without the need for a weld or brazed connection of these portions. Turns 512, 516 are joined via the interconnecting member 514, and lead portions 522, 526 merge into capacitive plate portions 530, 532 with an interleaved dielectric material 534 (FIG. 14) that also serves as a mechanical spacer. This arrangement provides a multi-turn coil from a single sheet of metal that eliminates a weld or brazed interconnection as used in conventional arrangements. This embodiment, like the other embodiments of this disclosure, is easier to manufacture, less expensive to manufacture, and eliminates discontinuities in the coil that would otherwise cause hot spots during operation.

Although the illustrated embodiments show only two turns, it will be appreciated that a greater number of multiple turns can be incorporated into other similar arrangements made from a single sheet without including a welding or brazing operation. The connection between turns is advantageously moved from an inner diameter region to the outer perimeters of the multiple turns, and the folding/forming between turns provides a continuous piece of metal. Large cross-sectional areas of metal can also be integrated into the design to facilitate heat conduction away from the coil.

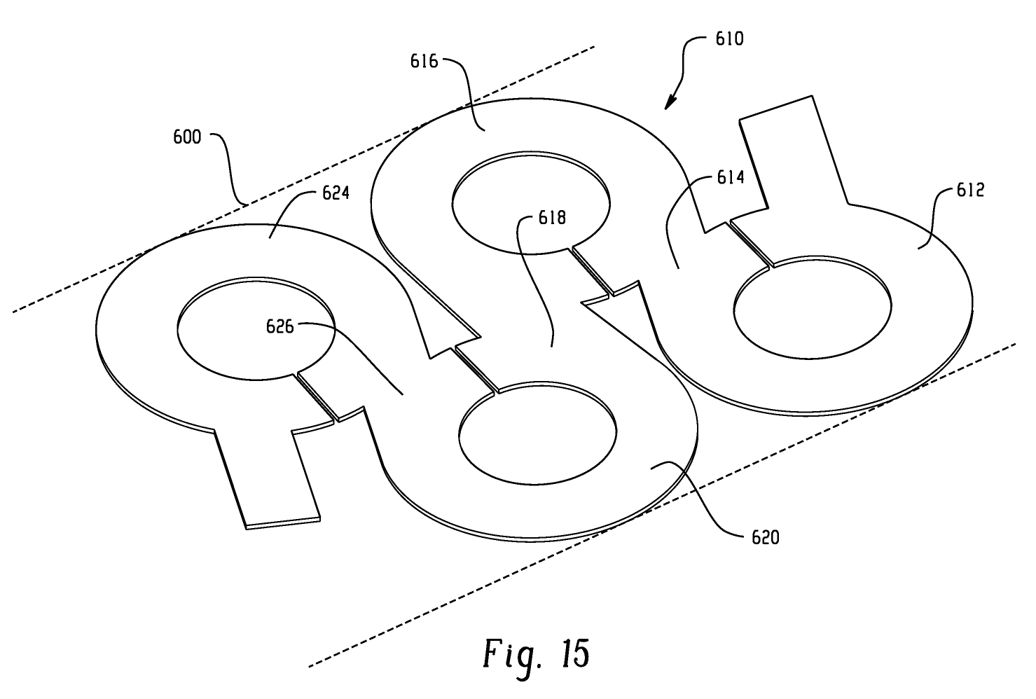

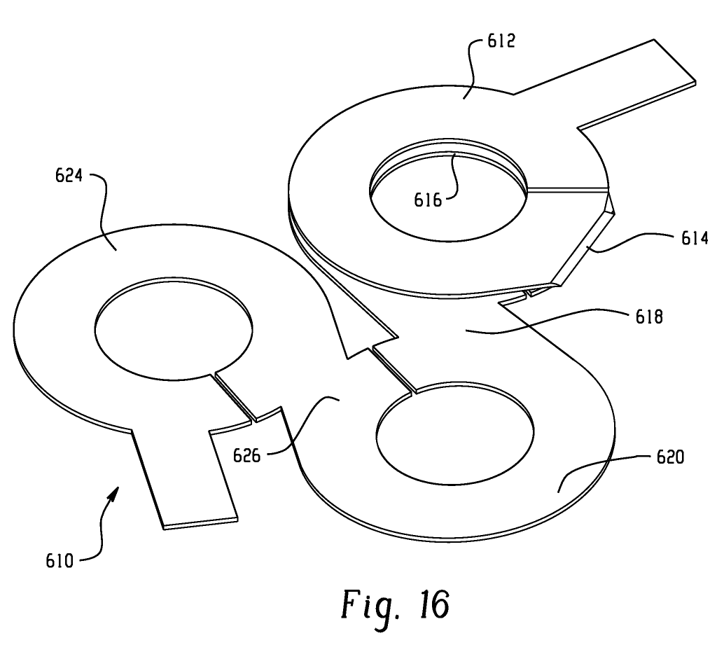

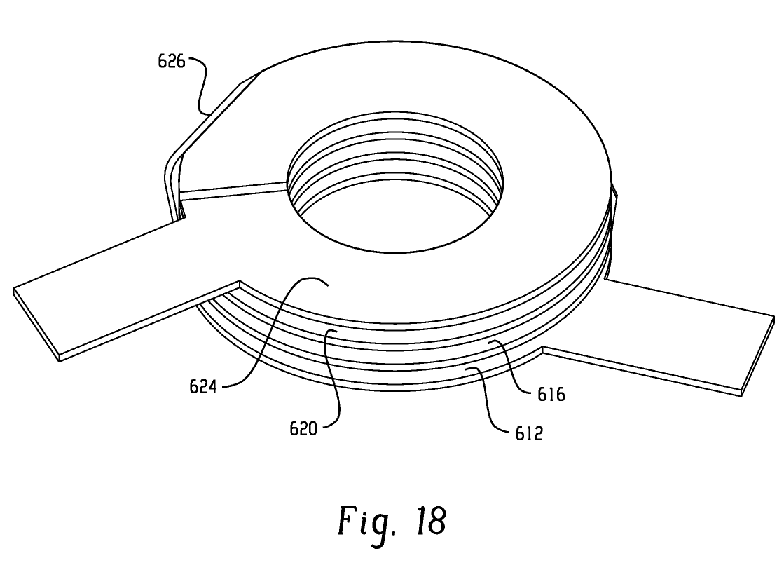

Additional preferred embodiments are shown in FIGS. 15-18, demonstrating embodiments having “n” turns, and in the particular illustrated examples where n=4. Any number of turns, even an arbitrarily large number of turns, could be produced from a single uncut sheet 600 of conductive metal material. The configuration of a stamped and cut component 610 for forming a multi-turn coil includes a first turn 612 that extends from an interconnecting portion 614. The other end of the interconnecting portion is provided with a second turn 616. In this case, each turn extends through an angle somewhat less than 360°, but so that each turn provides slightly less than one equivalent turn of a transformer. Moreover, and as evident in FIG. 15, the component 610 as stamped and separated from the sheet is disposed in a single plane, and then folded into the configuration shown in FIG. 16 where the interconnecting portion 614 is folded along an intermediate region so that the first and second turns 612, 614 are disposed in first and second parallel, overlapping planes. The turns 612, 616 become co-axial in this arrangement and likewise the first and second turns have substantially co-extensive inner and outer perimeters, i.e., they are aligned relative to one another. The configuration of a stamped and cut component 610 for forming a multi-turn coil also includes a third turn 620 that extends from an interconnecting portion 618, and a fourth turn 624 that extends from an interconnecting portion 622. Any number of additional turns and interconnecting portions can be so added. In this case, each turn extends through an angle approaching 360°, but somewhat smaller so that each turn provides slightly less than one equivalent turn of a transformer. However, since an arbitrarily large number of turns may be thus added, any number of equivalent turns of a transformer may be functionally created. Moreover, and as evident in FIG. 15, the component 610 as stamped and separated from the sheet is disposed in a single plane, and then folded into the configuration shown in FIG. 16 where the interconnecting portion is folded along intermediate regions so that each of the turns is disposed in a separate, parallel, overlapping plane. The turns 612, 616, 620, 624 become co-axial in this arrangement and likewise each turn has substantially co-extensive inner and outer perimeters, i.e., they are aligned relative to one another (FIG. 18).

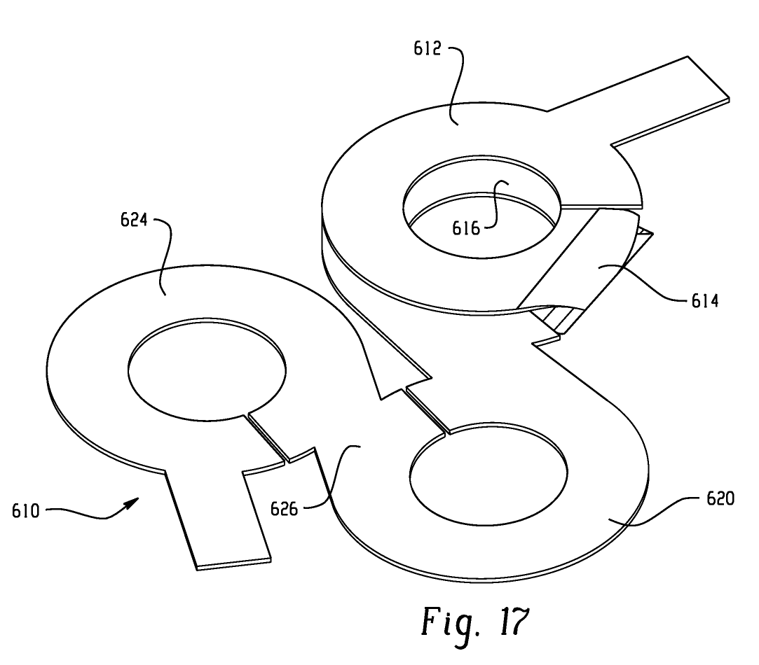

This design fills in the open gaps around the circumference between turns of the coil (compare with earlier embodiments). The first turn is folded on top of the second turn as described above and illustrated in FIG. 16, for example, with a 1 mm air gap between the turns. Likewise, subsequent turns will be folded in a similar manner to minimize the gap between adjacent turns (adjacent layers) of the coil. Alternatively, and as illustrated in FIG. 17, the air gap may be easily altered by changing the conformation of the fold. In this illustrated example, the air gap is increased, such as on the order of 6 mm air gap between adjacent turns of the coil, although still other dimensional arrangements may be used without departing from the scope and intent of the present disclosure. Increasing the air gap may be advantageous for emission of light from the lamp assembly. On the other hand, decreasing the air gap between the coils may advantageously prevent light from entering the gap between the turns, and may also contribute significant capacitance to the inductive coils which can advantageously reduce the size of the parallel plate capacitors. The air gap may be reduced significantly by replacing the air by a suitable high-temperature, high-dielectric material such as pyrolytic boron nitride, or other suitable nitride or oxide. The pyrolytic form of BN, or pyrolytic graphite, or similar materials have an added advantage of significantly higher thermal conductivity than the substrate metal, for example Al, and therefore the pyrolytic BN helps substantially to remove the heat dissipated in the coil, which reduces the electrical resistance and the ohmic losses of the coil. In FIG. 18, the final folded 4-turn coil is shown.

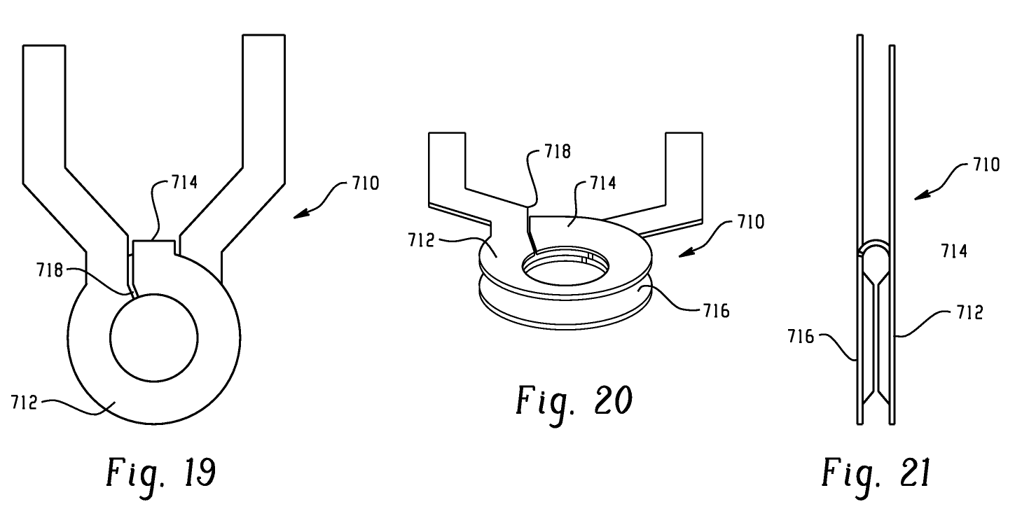

FIGS. 19-21 illustrates how the coil can easily undertake or adopt a conical or cup shape without significant alteration to the basic conformation of the component cut from the planar sheet metal blank. Specifically, multi-turn coil 710 includes a first turn 712 having an interconnecting region 714 that joins the first turn to a second turn 716. In the previous embodiments, the individual turns of the coil are shown in planar, parallel relation where the plane of each turn is substantially perpendicular to an axis of rotation of each turn. In FIGS. 19-21, a chamfer 718 may be provided so that each turn can be stamped or bent into a conical or cupped configuration. Again, each turn of the multi-turn coil is substantially parallel to the next adjacent turn of the coil.

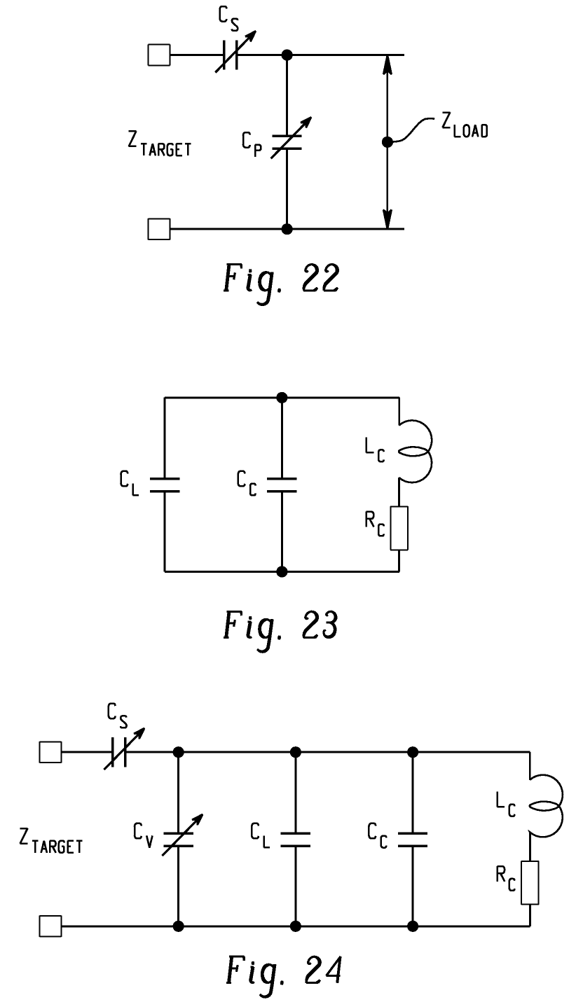

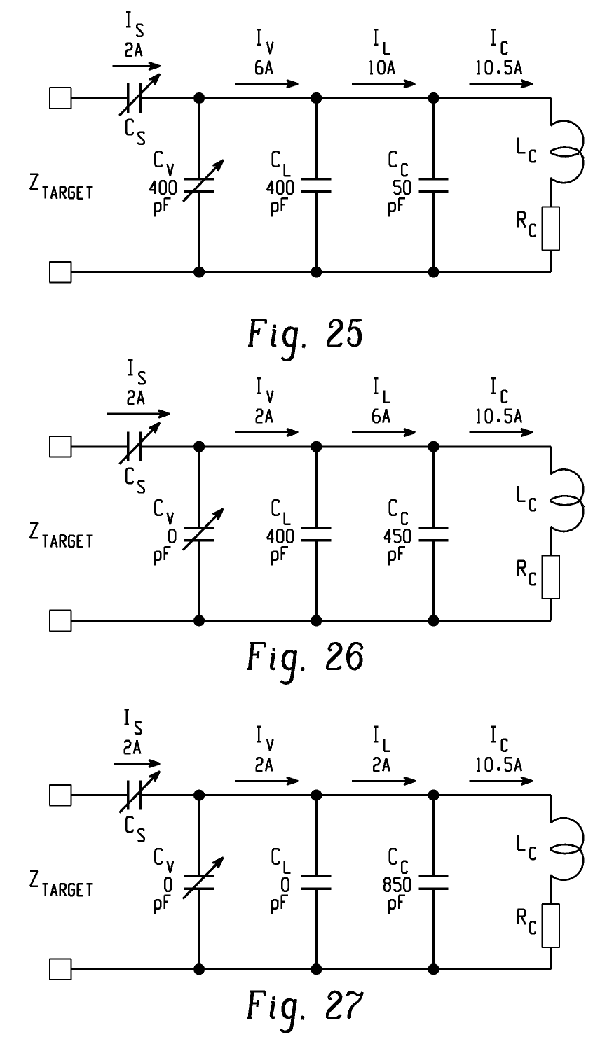

As noted previously, the lead portions may be extended and in some embodiments the lead portions form a part of the capacitance portion of the lamp assembly. In prior designs, either external solid RF capacitors or extra metal plates with a dielectric material between them were used as the parallel capacitor to match the lamp/coil impedance to the desired impedance of the RF amplifier. In this arrangement the matching parallel capacitor is integrated into the coil itself such that the path between the coil and the parallel capacitor is minimized. FIG. 22 shows a typical L-shaped matching network using two capacitors Cₛ and Cₚ to match the load impedance Z_{load} to required impedance Z_{target}. FIG. 23 shows an electrical model of the multi-turn coupling coil of the present disclosure where L_{c} is the inductance formed by the adjacent turns, C_{c} is the capacitance formed by the adjacent turns, C_{L} is the capacitance formed by the metal plates as mentioned above or the leads of the coupling coil, and R_{c} is the resistance of the coil. FIG. 24 shows the circuit to match the impedance of the coupling coil to the required impedance Z_{target}. Once the Z_{target}, L_{c} and R_{c} are determined by design, the required parallel capacitance Cₚ of matching network is determined too where Cₚ includes three portions: C_{V}, C_{L} and C_{c}, i.e. C_{V}+C_{L}+C_{c}=Cₚ. In prior coupling coil designs, air is between the adjacent turns. Since air has a dielectric constant of 1, the capacitance formed by the adjacent turns C_{c} is much smaller when compared to C_{V} and C_{L}. FIG. 25 shows an example of a standard coupling coil matching circuit with the capacitance values and current distribution. FIG. 26 shows an example of the matching circuit when the parallel capacitance of C_{V} is moved to C_{c} and also shows the current distribution. FIG. 27 shows an ideal case when both parallel capacitance C_{V} and C_{L} are shifted to C_{c} and also shows the optimal current distribution. By comparing FIGS. 25, 26 and 27, it is clear that the high current path is shortened when the most portion of matching parallel capacitance cₚ is shifted to close to the adjacent turns, ideally to adjacent turns themselves. Therefore, the power loss is reduced and the system efficiency can be improved. In FIG. 27, the required high current to generate magnetic field is confined in the adjacent turns themselves. The current in the rest of circuit is significantly lower such that the system efficiency is maximized.

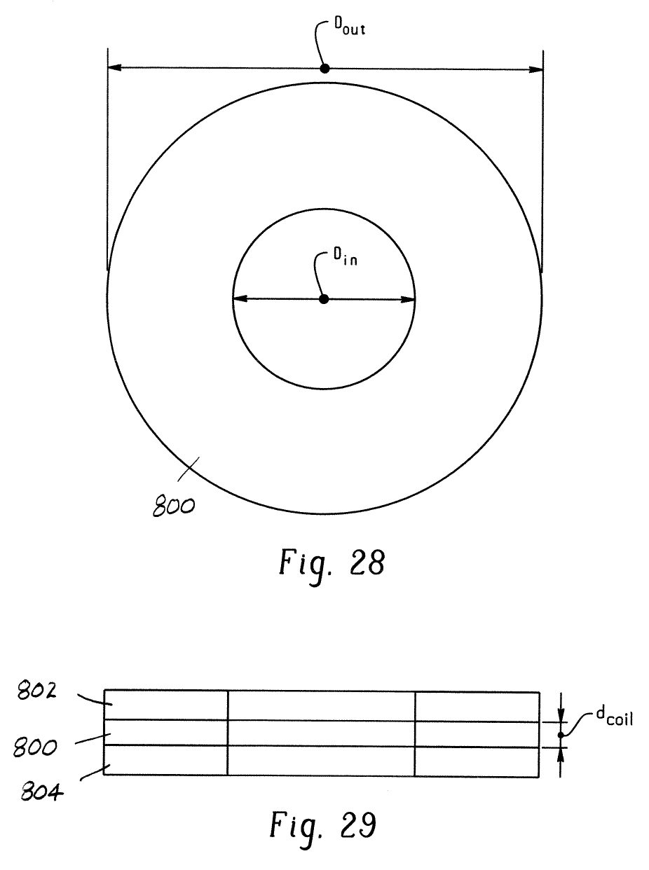

From above analysis, the high current path can be minimized by moving parallel matching capacitance to the adjacent turns themselves. FIG. 28 shows a coupling coil with integrated capacitor. A high temperature, high dielectric constant material 800, such as ceramic, is put between the adjacent turns 802, 804 to enhance the capacitance C_{c}. High dielectric constant ceramic has a dielectric constant range from 100 to 1000 which will increase the capacitance of C_{c} dramatically compared to air (dielectric constant of air is 1). Capacitance C_{c} can be increased by reducing the gap d_{coil} between the adjacent turns. The coupling coil with a smaller gap between adjacent turns will allow more light emitted by the lamp to hit the optics and increase optical efficiency. Capacitance C_{c} can be increased further by enlarging the surface area of the turns. The surface area of the turns can be enlarged by increasing the outside diameter Dₒᵤₜ of the turns or decreasing the inside diameter Dᵢₙ of the turn. Also, an enlarged coil surface helps to conduct the heat away from the coil to the ambient environment and thereby reduces the temperature of the coil.

A preferred process for forming the coil from a single flat sheet of electrically conductive material includes mechanical means of removing material such as stamping or cutting. It will be appreciated, however, that alternative processes can be used, for example, thermal means such as torches or lasers, or electrical means such as electric discharge machining, or chemical means such as etching, or deposition means of adding material such as vapor deposition, or ink jet deposition, or painting or spraying. Of course, still other processes or combination(s) of these processes could be used without departing from the scope and intent of the present disclosure. Likewise, the process for folding or displacing the material from a single flat sheet into a multi-turn coil arrangement can include manual or automated machinery, or a combination of the two.

The disclosure has been described with reference to the preferred embodiments. Obviously, modifications and alterations will occur to others upon reading and understanding the preceding detailed description. It is intended that the disclosure be construed as including all such modifications and alterations.

1. A multi-turn coil comprising:
a single sheet of electrically conductive material having at least a first turn in a first plane and at least a second turn in a second plane, the first plane parallel to the second plane; and
one interconnecting fold connecting each pair of the at least first and second turns.

2. The coil of claim 1 wherein the first plane is parallel to a plane of any additional turn.

3. The coil of claim 1 wherein one additional interconnecting fold connects adjacent, additional turns.

4. The coil of claim 1 wherein the first turn extends through substantially 360 degrees.

5. The coil of claim 4 wherein the second turn extends through substantially 360 degrees.

6. The coil of claim 1 wherein the interconnecting fold is located along an outer perimeter portion of the first and second turns.

7. The coil of claim 1 wherein the first and second turns are coaxial.

8. The coil of claim 1 wherein the first and second turns have substantially coextensive inner and outer perimeters.

9. The coil of claim 1 wherein the first and second turns have lead portions extending in generally tangential, parallel planes relative to the turns.

10. The coil of claim 9 wherein the first and second turns extend in parallel relation from the turns past outer perimeter portions of the turns.

11. The coil of claim 1 wherein sheet of electrically conductive material has a thickness dimension substantially less than a width dimension.

12. The coil of claim 1 further comprising first and second plate portions extending from the first and second turns, respectively.

13. The coil of claim 12 wherein the first and second plate portions are disposed in parallel relation.

14. The coil of claim 13 wherein the first and second plates form a capacitive element.

15. The coil of claim 13 wherein the first and second plate portions are disposed generally perpendicular to the first and second planes.

16. The coil of claim 13 wherein the first and second turns have first and second lead portions that extend in generally tangential relation from the turns and interconnect the first and second turns with the first and second plate portions, respectively.

17. The coil of claim 16 wherein the first and second lead portions have substantially the same cross-sectional area as the first and second turns.

18. A method of forming a multiple turn coil comprising:
providing a continuous strip of conductive material having first and second turns that extend through substantially 360 degrees and are formed in a first plane; and
displacing at least the first turn from the first plane into generally overlapping, parallel relation with the second turn.

19. The method of claim 18 wherein the displacing step includes folding the strip of conductive material substantially 180 degrees to align the first turn over the second turn.

20. The method of claim 18 wherein the providing step includes initially orienting the first and second turns in the first plane interconnected by an interconnecting portion, the first and second turns proceeding from the interconnecting portion in opposite hand directions from each other.

21. The method of claim 18 further comprising forming first and second plate portions that extend from the first and second turns, respectively.

22. The method of claim 21 wherein the plate portion forming step includes orienting the plate portions in substantially parallel relation with one another.

23. The method of claim 22 wherein the parallel orienting step includes further orienting the plate portions in substantially perpendicular relation with the first and second turns.

24. The coil of claim 1 further comprising a high temperature dielectric material disposed between the first and second turns.

25. The coil of claim 24 wherein the dielectric material is one of a ceramic, mica, or high temperature, high electrical resistivity, and high dielectric constant material.

26. The coil of claim 24 wherein the capacitor includes a similarly dimensioned conductive layer disposed adjacent the first turn and interconnected therewith via the dielectric material.

27. The coil of claim 24 wherein a capacitance of the turns of the coil of an excitation coil portion are disposed in parallel relation with a capacitor portion.

28. The coil of claim 27 wherein a high current path is reduced by shifting parallel matching capacitance to the first and second turns of the coil.

29. The coil of claim 1 used in a lamp having an arc discharge body.

30. The coil of claim 27 wherein the arc discharge body is an electrodeless arc discharge body and further includes a ballast operatively associated with the coil.

31. The coil of claim 1 wherein the first turn includes a chamfer cut to facilitate shaping of the first and second turns.
